(19) United States
(12) Patent Application Publication
(10) Pub. No.: US 2023/0310124 A1
(43) Pub. Date: Oct. 5, 2023

(54) DENTAL APPLIANCE AND METHOD OF USE FOR DENTAL ARCH AND/OR AIRWAY DEVELOPMENT AND TEETH POSITIONING

(71) Applicant: Martin Gorman, Encino, CA (US)

(72) Inventor: Martin Gorman, Encino, CA (US)

(21) Appl. No.: 18/142,563

(22) Filed: May 2, 2023

Related U.S. Application Data
(63) Continuation-in-part of application No. 17/959,965, filed on Oct. 4, 2022.
(60) Provisional application No. 63/266,899, filed on Jan. 18, 2022.
(60) Provisional application No. 63/251,810, filed on Oct. 4, 2021.

(51) Int. Cl. A61C 7/10; A61C 7/36

(52) U.S. Cl. CPC A61C 7/10; A61C 7/36

(57) ABSTRACT

A succession of dental appliances may be used to provide jaw bone remodeling. The jaw bone remodeling may provide for treatment of snoring or sleep disordered breathing, and may provide for pharyngeal airway remodeling. The dental appliances may have an outside wall, an inside wall, and a channel to receive a dental arch between the inside wall and the outside wall. The inside wall may extend so as to apply pressure to a bone structure, when worn by a user. The channel may include indentations to receive portions of teeth, and the indentations may be dimensioned and positioned so as to apply pressure to one, some, or all of the teeth. The succession of dental appliances may have successively greater arch widths and/or lengths, and may orthodontically reposition the teeth, and may provide tongue space which may provide larger nasal passages.

### CROSS-REFERENCE TO RELATED APPLICATIONS

This application is a continuation-in-part of U.S. Pat. Application No. 17/959,965, filed on Oct. 4, 2022, which claims the benefit of the filing dates of U.S. Provisional Pat. Application No. 63/251,810, filed on Oct. 4, 2021, and U.S. Provisional Pat. Application No. 63/266,899, filed on Jan. 18, 2022, the disclosures of all of which are incorporated by reference herein.

### FIELD OF THE INVENTION

The present invention relates generally to dental appliances, and more specifically to dental appliances and methods for upper and/or lower jaw expansion, which possibly may result in pharyngeal airway growth and/or remodeling, and simultaneous teeth positioning and/or orthodontic movement.

### BACKGROUND OF THE INVENTION

Small, underdeveloped upper and lower jaws may result in small or narrow nasal passages, and can cause improper positioning of the tongue at rest, for example during sleep, and blockage or narrowing of the airway. This improper positioning and narrowing possibly may decrease the amount of oxygen individuals obtain when breathing, decrease extent of nasal breathing, and increase incidents of Sleep Apnea, snoring, temporomandibular disorders (TMD), malocclusion, and a host of other serious health issues in both children and adults.

Relatedly, statistics as of 2021 suggest that 45% of people in the US need to have their teeth straightened--a quiet epidemic. There are often approximately 4 million children and adults that are in some type of orthodontic procedure to straighten their teeth, adults make up about 25% of this number. But this number may be misleading, as recent research may indicate that 50 to 75% of the US population suffers from malocclusion (bad bite), which may result in crowded teeth, misaligned teeth, TMD and airway issues.

Malocclusion has been the bread and butter to Western Dentistry for the past 75 years. Not only did it create Orthodontists, but it has also kept Pulmonologists, (ENTs) and regular Dentists busy because of the underlying condition that causes malocclusion and the issues that those causes create.

Over 50% of children may need some type of Orthodontia. There is also an epidemic in the adult population of Sleep Apnea, TMD, depression, and a host of other issues that may be jaw size, tooth position, or airway related. All of these serious health issues have been linked to a lack of space for the tongue, for example falling back and blocking the airway, when sleeping. Lack of space may force the tongue to slide back and cut off the airway, causing breathing to be stressed or difficult, especially when resting or sleeping.

Dentists have often been treating malocclusion in children and adults, by traditional orthodontia, which are metal braces, ceramic braces and lingual braces, that we are all familiar with. Such treatment may be temporary, as it may not treat the underlying causes of the malocclusion. Dentists and Orthodontists may also approach overcrowding of teeth by extracting teeth. Unfortunately, this may again just be a temporary fix, and possibly lead to complications later in life and again does not address the underlying cause. Later in life complications may include Snoring, Sleep Apnea, Hypertension and many other serious health issues.

The computer age brought a new type of orthodontic device to mainstream teeth straightening via the advent of the CAD system and high-end thermoplastics. In the late 90′s a Stanford grad student took his knowledge of computers and his noncompliance with his traditional retainers and invented a system that could mass produce clear aligners to replace metal braces. These clear aligners brought in a whole new segment of the population that was suffering from malocclusion, because they were essentially invisible, comfortable, and only took a maximum of 2-3 years for the aligners to work. The clear aligner market was set, but it again did not treat the underlying cause of malocclusion, for example small jaws and small airways.

The costs of these types of malocclusion treatments may be as follows: (1) Metal Braces: $3,000 to $7000; (2) Ceramic Braces: $4000 to $8000; (3) Lingual Braces: $8000 to $10000; and (4) Clear Aligners: $4000 to $7400. These treatments may not be permanent, and, without long term retainers and chair time for the Dentist, malocclusion can return, for example as the root cause is generally not addressed.

Airway related treatments may also be insufficient. Traditional medicine/dentistry has generally only treated the symptoms of these diseases and disorders through medication, surgery and cumbersome machines, possibly leaving sufferers a lifetime of medication or being hooked up to a machine at night or bulky oral appliances, that all may cause additional symptoms or issues. There are now even electronic implants that electrically shock your system that forces your throat to open more when sleeping at night to allow for better airway flow.

### BRIEF SUMMARY OF THE INVENTION

Aspects of the present invention relate to the fusion of two separate oral health treatments, airway expansion and malocclusion correction, that separately affect more than 50% of the population and cause billions of dollars in healthcare costs. Some embodiments may address the underlying root cause of the focus of those treatments, small airways and teeth crowding, and ameliorate or correct that condition. Some embodiments may do so while decreasing treatment time and/or the patient cost, while possibly increasing patient compliance and success of treatment.

Some embodiments may decrease an amount of time necessary for treatment by approximately 66%, for example from 36-48 months to 12-18 months. Some embodiments may decrease cost of treatment by more than half, for example from a high of $16,000 to $6,000, while also decreasing the amount of “chair time” and increasing compliance due to possible reduction or elimination of pain in wearing and/or visibility, and, possibly in many instances, noticeable desired visible results.

Some embodiments may do so through concurrent jaw expansion by way of bone growth and tooth repositioning, or through at least partial overlap of jaw expansion by way of jaw bone growth and tooth repositioning. In some embodiments the tooth repositioning is independent of any tooth repositioning that occurs due to jaw expansion by way of jaw bone growth. In some embodiments a sequence of dental appliances provide for jaw expansion by way of jaw bone growth through application of radially forward pressure to lingual attached gingiva, and therefore a jaw bone, of a user. In some embodiments the jaw bone growth is accomplished without reduction or significant reduction of bone volume about teeth sockets. In some embodiments application of the sequence of dental appliances moves a user’s teeth radially forward without reduction in width, or significant reduction in width, between buccal walls of the jaw bone and teeth sockets. In some embodiments the dental appliances circumferentially encase the user’s teeth and extend over at least some portions of both the lingual and buccal attached gingiva of the user’s gums, in some embodiments to reduce or avoid undesired flaring or tilting of the teeth and/or reduction in bone between buccal walls of the jaw bone and teeth sockets. In some embodiments the sequence of dental appliances, or some dental appliances in the sequence, also reposition one or more teeth laterally and/or rotationally with respect to the jaw bone.

In some embodiments the dental appliances are applied to users with secondary or adult dentition. In some such embodiments indentations for teeth of the dental appliances are dimensioned to receive teeth of an adult dentition. In some embodiments the dental appliances are applied to users with primary dentition. In some such embodiments indentations for teeth of the dental appliances are dimensioned to receive teeth of a primary dentition. In some embodiments the dental appliances are applied to user with mixed dentition. In some such embodiments indentations for teeth of the dental appliances are dimensioned to receive teeth of a primary dentition and teeth of an adult dentition.

Some embodiments provide dental appliances for jaw remodeling and at least partially simultaneous teeth positioning, comprising: a plurality of dental appliances, each dental appliance including an outside wall and an inside wall, with a channel to receive teeth of a dental arch between the outside wall and the inside wall, the channel including indentations to receive at least some of the teeth of the dental arch, the inside wall extending so as to be parallel to at least one bone structure supporting teeth of the dental arch, so as to apply pressure to the at least one bone structure in a direction towards a surface defined by the outside wall; wherein the dental appliances provide a succession of dental appliances, each of the dental appliances in the succession having inside walls having a greater arch width and/or length than a prior dental appliance in the succession; and wherein at least some of the dental appliances in the succession have at least some indentations positioned in the channel so as to provide linear and/or rotational pressure to teeth positioned in the indentations. In some embodiments the indentations of at least some of the dental appliances in the succession are positioned to apply linear and/or rotational pressure to teeth such that the teeth have a mid-line in a middle of a user’s face. In some embodiments the indentations of at least some of the dental appliances in the succession are positioned to apply linear and/or rotation pressure to teeth so as to substantially position the teeth on a smooth curve defined by the dental arch. In some embodiments the indentations of at least some of the dental appliances in the succession are positioned to apply linear and/or rotational pressure to teeth so as to move teeth to obtain a desired spacing between teeth.. In some embodiments the inside wall is dimensioned to extend over at least 1 mm of lingual attached gingiva of a user. In some embodiments the inside wall is dimensioned to extend over at least 3 mm of lingual attached gingiva of a user. In some embodiments the outside wall is dimensioned to extend over at least 1 mm of buccal attached gingiva of a user. In some embodiments the outside wall is dimensioned to extend over at least 3 mm of buccal attached gingiva of a user. In some embodiments each dental appliance in the succession has an arch width and/or length between 0.15 and 0.30 millimeters greater than an arch width and/or length of an immediately preceding dental appliance in the succession. In some embodiments the dental appliances comprise maxillary dental appliances. In some embodiments the maxillary dental appliances include a surface extending across the dental arch, with the surface configured so as to be about a palate of an individual who is to wear the maxillary dental appliances. In some embodiments the surface extends from upper edges of the inside wall of the maxillary dental appliance. In some embodiments the surface connects the upper edges of the inside wall of the maxillary dental appliance. In some embodiments an apex of the surface of each maxillary dental appliance in the succession of dental appliances is configured to be between 0.25 mm and 1.0 mm below an apex of an immediately prior maxillary dental appliance in the sequence of dental appliances. In some embodiments the dental appliances comprise mandibular dental appliances. In some embodiments the dental appliances are formed of a polymer. In some embodiments the polymer is an acrylic polymer. In some embodiments the outside wall, inside wall, and channel are integrally formed of an acrylic polymer. In some embodiments the positions of the indentations for at least some of the teeth provide for orthodontic positioning of the at least some of the teeth by at least some of the different ones of the dental appliances. In some embodiments the indentations are dimensioned for teeth of a primary dentition. In some embodiments the indentations are dimensioned for teeth of an adult dentition. In some embodiments the indentations are dimensioned for teeth of a mixed dentition.

Some embodiments provide a method of jaw remodeling with at least partially simultaneous teeth positioning, comprising: applying radially outward pressure to lingual attached gingiva of a dental arch using a dental appliance having indentations substantially encasing portions of teeth extending beyond a gum line of an individual; and simultaneously with the application of radially outward pressure to the lingual attached gingiva using the dental appliance, applying linear and/or rotational pressure to at least some of the teeth using the dental appliance, so as to reposition the teeth with respect to the dental arch. Some embodiments further comprise: applying radially outward pressure to the lingual attached gingiva of the dental arch using a succession of further dental appliance having indentations substantially encasing portions of teeth extending beyond the gum line of the individual; and simultaneously with the application of radially outward pressure to the lingual attached gingiva using at least some of the further dental appliances, applying linear and/or rotational pressure to at least some of the teeth using the at least some of the further dental appliances, so as to reposition the teeth with respect to the dental arch. In some embodiments the dental appliance and the succession of further dental appliances are used in a sequence. In some embodiments the succession of further dental appliances follow the dental appliance in the sequence. In some embodiments a first dental appliance in the sequence is not the dental appliance and is not one of the at least some of the further dental appliances. In some embodiments the linear and/or rotational pressure applied to teeth applies the pressure such that the teeth have a mid-line in a middle of a user’s face. In some embodiments the at least some of the dental appliances orthodontically position the teeth through positioning of the indentations. In some embodiments the dental appliance includes an outside wall and an inside wall, with a channel to receive teeth of a dental arch between the outside wall and the inside wall, and the inside wall applies the pressure to the lingual attached gingiva. In some embodiments the inside wall extends at least 1 mm over the lingual attached gingiva past a line demarcating a boundary between marginal gingiva and the lingual attached gingiva. In some embodiments the inside wall extends at least 3 mm over the lingual attached gingiva past a line demarcating a boundary between marginal gingiva and the lingual attached gingiva. In some embodiments the inside wall extends 1 to 3 mm over the lingual attached gingiva past a line demarcating a boundary between marginal gingiva and the lingual attached gingiva. In some embodiments the outside wall extends at least 1 mm over buccal attached gingiva past a line demarcating a boundary between marginal gingiva and the buccal attached gingiva. In some embodiments the outside wall extends at least 3 mm over buccal attached gingiva past a line demarcating a boundary between marginal gingiva and the buccal attached gingiva. In some embodiments the outside wall extends 1 to 3 mm over buccal attached gingiva past a line demarcating a boundary between marginal gingiva and the buccal attached gingiva. In some embodiments the teeth are teeth of a primary dentition or an adult dentition. In some embodiments the teeth are teeth of a mixed dentition.

Some aspects of the invention provide a plurality of dental appliances, each dental appliance including an outside wall and an inside wall, with a channel to receive a dental arch between the outside wall and the inside wall, the inside wall extending, in a same direction as the channel, sufficiently far to be parallel to at least one bone structure supporting teeth of the dental arch, so as to apply pressure to the at least one bone structure in a direction towards a surface defined by the outside wall, each of the plurality of dental appliances having inside walls having different arch widths and/or lengths. In some aspects the dental appliances may be arranged in a succession of dental appliances, each dental appliance in the succession having a greater arch width and/or length than a prior dental appliance in the succession. In some embodiments each dental appliance in the succession has an arch width and/or length between approximately 0.17 to 0.40 millimeters (or more in some embodiments) greater than an arch width and/or length of an immediately preceding dental appliance in the succession. In some embodiments each dental appliance in the succession has an arch width and/or length between approximately 0.17 to 0.25 millimeters greater than an arch width and/or length of an immediately preceding dental appliance in the succession. In some embodiments each dental appliance in the succession has an arch width and/or length approximately 0.17 millimeters greater than an arch width and/or length of an immediately preceding dental appliance in the succession. In some embodiments each dental appliance in the succession has an arch width and/or length approximately 0.25 millimeters greater than an arch width and/or length of an immediately preceding dental appliance in the succession. In some embodiments one of the dental appliances is a maxillary dental appliance and another of the dental appliances is a mandibular dental appliance. In some embodiments the maxillary dental appliance includes a surface extending across the dental arch, with the surface configured so as to be about or vertically cover a palate of an individual who is to wear the maxillary dental appliance. In some embodiments the surface connects extends from upper edges of the inside wall of the maxillary dental appliance. In some embodiments the surface connects the upper edges of the inside wall of the maxillary dental appliance. In some embodiments the surface forms a continuous surface. In some embodiments the surface covers an area within an arch formed by the upper edges of the inside wall of the maxillary dental appliance. In some embodiments the surface of each maxillary dental appliance in the succession of dental appliances, or at least some of the maxillary dental appliances in the succession of dental appliances, is configured, at least in part, to be 0.25 to 1.0 mm below the palate of the individual who is to wear the maxillary dental appliance, at the time the individual is to begin wearing the maxillary dental appliance. In some embodiments the surface of each maxillary dental appliance in the succession of dental appliances, or at least some of the maxillary dental appliances in the succession of dental appliances, is configured, at least in part, to be 0.25 mm below the palate of the individual who is to wear the maxillary dental appliance, at the time the individual is to begin wearing the maxillary dental appliance. In some embodiments the surface of each maxillary dental appliance in the succession of dental appliances is configured, at least in part, to be 1.0 mm below an apex of the palate of the individual who is to wear the maxillary dental appliance, at the time the individual is to begin wearing the maxillary dental appliance. In some embodiments an apex of the surface of each maxillary dental appliance in the succession of dental appliances is configured to be 0.25 mm below an apex of an immediately prior maxillary dental appliance in the sequence of dental appliances, or at least some of the maxillary dental appliances in the succession of dental appliances. In some embodiments the apex may be considered to be lowered for at least some of the successive maxillary dental appliances, to allow for greater ease of lowering the individual’s palate. In some embodiments the dental appliances are formed of or comprise one, some or all of polyethylene terephthalate (PET), polyethylene terephthalate glycol (PET-G), PET (Pfb/PFc), Polyurethane, a multi-layer polyurethane, or a multi-layer aromatic thermoplastic polyurethane. In some aspects the dental appliances are formed of a polymer. In some embodiments the polymer is an acrylic polymer. In some embodiments the outside wall, inside wall, and channel are integrally formed of an acrylic polymer. In some embodiments the channel includes indentations for at least some teeth of the dental arch. In some embodiments the channel includes indentations for all of the teeth of the dental arch. In some embodiments positions of the indentations for at least some of the teeth reflect a desired spacing between teeth across different ones of the dental appliances. In some embodiments the positions of the indentations for at least some of the teeth provide for orthodontic positioning of the at least some of the teeth by at least some of the different ones of the dental appliances. In some embodiments the orthodontic positioning of the teeth is provided by each dental appliance in the sequence of dental appliances.

Some aspects of the invention provide a method of increasing a width and/or length of a dental arch, comprising: providing a succession of dental appliances to a patient for wear by the patient, each dental appliance comprising a polymeric form including an outside wall and an inside wall, with a channel to receive a dental arch between the outside wall and the inside wall the inside wall extending, in a same direction as the channel, sufficiently far to be parallel to at least one bone structure supporting teeth of the dental arch, so as to apply pressure to the at least one bone structure in a direction towards a surface defined by the outside wall, each of the plurality of dental appliances having inside walls having different arch widths and/or lengths, each subsequent dental appliance in the succession having a greater arch width and/or length than a preceding dental appliance in the succession. In some embodiments the succession of dental appliances include indentations to receive teeth. In some embodiments the succession of dental appliances orthodontically position the teeth through positioning of the indentations.

These and other aspects of the invention are more fully comprehended upon review of this disclosure.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows an example cast of a maxillary dental arch and palate.

FIG. 2 shows an example cast of a mandibular dental arch.

FIG. 3 shows a lower rear internal perspective view of an example maxillary dental appliance.

FIG. 4 shows an upper rear internal perspective view of an example mandibular dental appliance.

FIG. 5A shows an upper rear internal perspective view of a maxillary dental appliance in accordance with aspects of the invention.

FIG. 5B shows an upper rear internal perspective view of a further maxillary dental appliance in accordance with aspects of the invention.

FIG. 6A shows a lower rear internal perspective view of a mandibular dental appliance in accordance with aspects of the invention.

FIG. 6B shows a lower rear internal perspective view of a further mandibular dental appliance in accordance with aspects of the invention.

FIG. 7 is a flow diagram of a process that may be used in making a sequence of dental appliances, in accordance with aspects of the invention.

FIG. 8 shows an upper rear internal perspective view of a further maxillary dental appliance, in accordance with aspects of the invention.

FIG. 9 shows a lower rear internal perspective view of the example maxillary dental appliance of FIG. 8, with a representation of a hook attached about a position a first molar.

FIG. 10 shows a lower rear internal perspective view of a further mandibular dental appliance, in accordance with aspects of the invention.

FIG. 11 shows an upper rear internal perspective view of the example mandibular dental appliance of FIG. 10, with a representation of a hook attached about a position a first molar.

FIG. 12 diagrammatically shows a facemask on a head of a patient, in accordance with aspects of the invention.

FIGS. 13A and 13B illustrate a top view of example mandibular dental undesired and desired, respectively, relative tooth positioning.

FIGS. 14A and 14B illustrate a side cross-sectional view through an incisor and a molar, respectively, of the maxillary dental appliance of FIG. 5A in use, in accordance with aspects of the invention.

FIGS. 15A and 15B illustrate a side cross-sectional view through an incisor and a molar, respectively, of the mandibular dental appliance of FIG. 6A in use, in accordance with aspects of the invention.

### DETAILED DESCRIPTION

Some embodiments provide for dental appliances that provide for jaw bone growth and simultaneous orthodontic positioning of teeth. In some embodiments the dental appliances provide for jaw bone growth by providing outward radial pressure to lingual attached gingiva, and hence the jaw bone. In some embodiments the dental appliances provide for orthodontic position of teeth by circumferentially encasing the teeth with indentations in the dental appliances, with relative position of the indentations with respect to the teeth applying pressure to linearly or rotationally translate the teeth. In some embodiments the dental appliances include inner and outer walls or surfaces that extend over and against lingual and buccal attached gingiva, respectively, of a user.

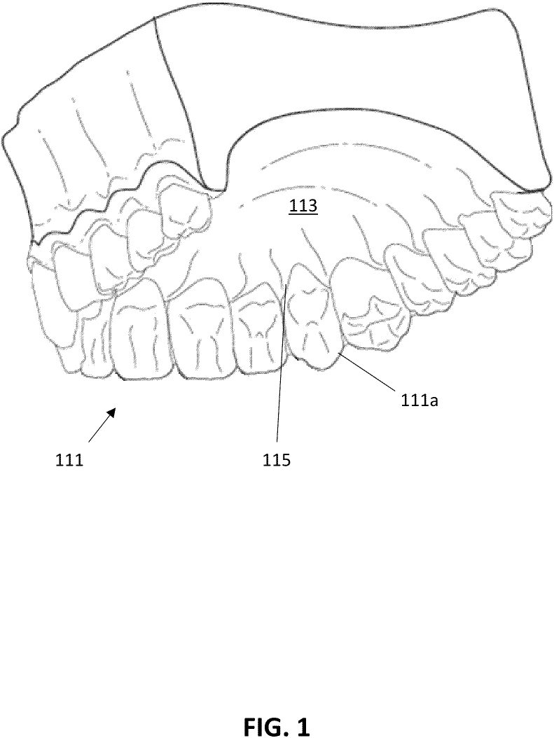

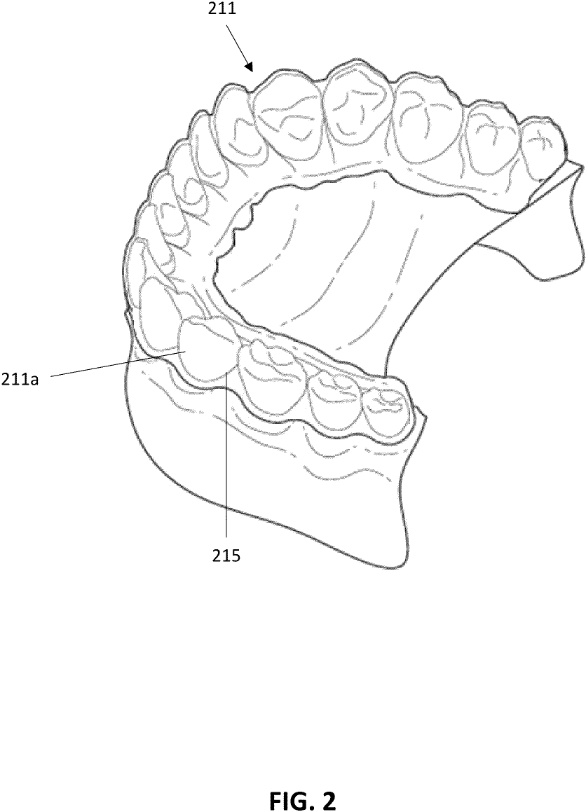

In some embodiments the dental appliances are formed using casts of a patient’s maxillary dental arch and mandibular dental arch. The casts may be made using dental impressions, for example. FIG. 1, for example, shows a cast of a maxillary dental arch 111 and palate 113. Teeth of the dental arch, e.g., tooth 111a, extend outward from gums comprised of marginal gingiva about a gum line 115 and attached gingiva attached to bone structure. FIG. 2, for example, shows a cast of a mandibular dental arch 211. Teeth of the dental arch, e.g., tooth 211a, extend outward from gums also comprised of marginal gingiva about a gum line 215 and attached gingiva attached to bone structure. The dental appliances may be formed using the casts of the dental arches, or information of the casts.

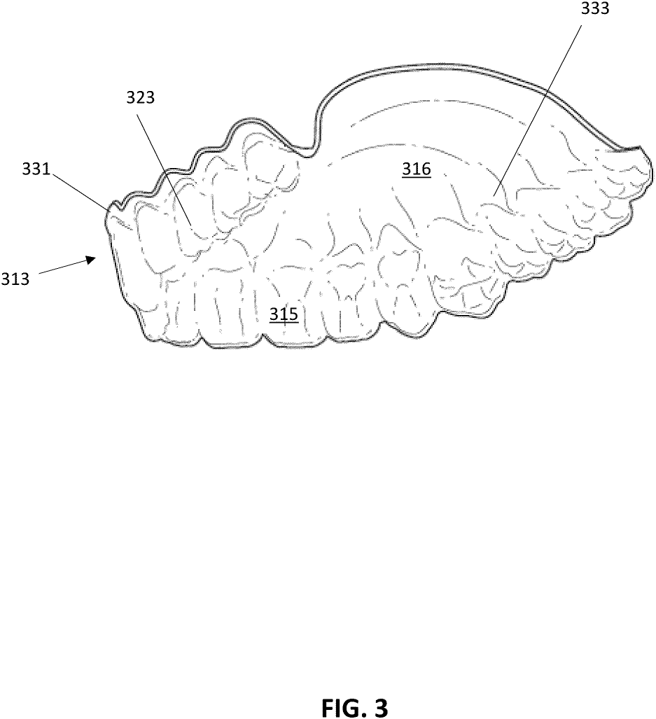

FIG. 3 shows a lower rear perspective view of an example maxillary dental appliance. The maxillary dental appliance includes a channel to receive a dental arch, the channel comprised of an outside wall 313 and an inside wall 315. The channel includes indentations to receive teeth of the dental arch, e.g., indentation 323. In some embodiments the indentations may be dimensioned to receive teeth of an adult dentition. In some embodiments the indentations may be dimensioned to receive teeth of a primary dentition. In some embodiments the indentations may be dimensioned to receive teeth of a mixed dentition. The outside wall extends over buccal sides of the teeth, and over at least portions of the buccal attached gingiva, with a portion, e.g. 331, of the outside wall extending over and/or against the portions of the buccal attached gingiva. In some embodiments the outside wall extends 3 to 4 mm, or more in some embodiments, past a line demarcating a boundary between the buccal marginal gingiva and the buccal attached gingiva. In some embodiments extent of extension of the outside wall over the buccal attached gingiva may depend on extent of availability of the buccal attached gingiva. In some embodiments the outside wall extends 1 to 3 mm past a line demarcating a boundary between the buccal marginal gingiva and the buccal attached gingiva A surface 316 connects top edges of the inside wall, for example to cover the palate.

In use, portions, e.g. 333, of the inside wall and/or surface 316 are dimensioned so as to apply outward radial pressure to lingual attached gingiva of a user, and hence to the underlying maxillary jaw bone. The radial outward pressure allows for outward expansion, or outward growth, of the jaw bone. Positions of the indentations for the teeth may also be selected so as to apply linearly and/or rotationally orthodontically position the teeth. In some embodiments the outside wall and/or indentations serve to prevent flaring or tilting of the teeth, and to preserve buccal jaw bone margin with respect to teeth and teeth sockets.

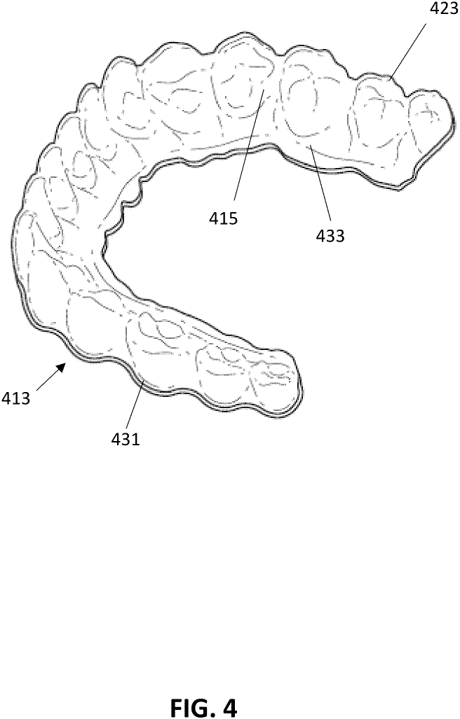

FIG. 4 shows an upper rear perspective view of an example mandibular dental appliance. The mandibular dental appliance also includes a channel to receive a dental arch, the channel comprised of an outside wall 413 and an inside wall 415. The channel includes indentations to receive teeth of the dental arch, e.g., indentation 423. In some embodiments the indentations may be dimensioned to receive teeth of an adult dentition. In some embodiments the indentations may be dimensioned to receive teeth of a primary dentition. In some embodiments the indentations may be dimensioned to receive teeth of a mixed dentition. The outside wall extends over buccal sides of the teeth, with portions, e.g. 431 over at least portions of the buccal attached gingiva. In some embodiments the outside wall extends 3 to 4 mm, or more in some embodiments, past a line demarcating a boundary between the buccal marginal gingiva and the buccal attached gingiva. In some embodiments extent of extension of the outside wall over the buccal attached gingiva may depend on extent of availability of the buccal attached gingiva.

In use, portions, e.g. 433, of the inside wall are dimensioned so as to apply outward radial pressure to lingual attached gingiva of a user, and hence to the underlying mandibular jaw bone. The radial outward pressure allows for outward expansion, or outward growth, of the jaw bone. Positions of the indentations for the teeth may also be selected so as to apply linearly and/or rotationally orthodontically position the teeth. In some embodiments the outside wall and/or indentations serve to prevent flaring or tilting of the teeth, and to preserve buccal jaw bone margin with respect to teeth and teeth sockets.

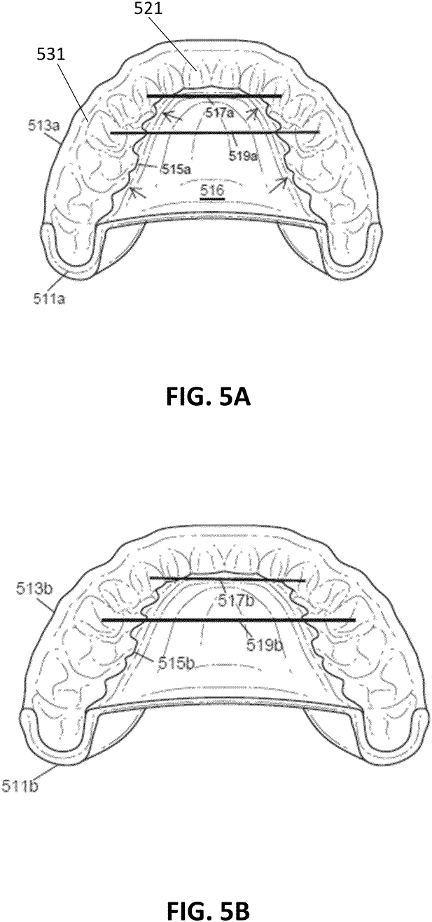

FIG. 5A shows an upper rear internal perspective view of a maxillary dental appliance in accordance with aspects of the invention. A generally U-shaped channel 511a is defined on its sides by an outside wall 513a and an inside wall 515a. The U-shaped channel generally follows a path of a dental arch, for example of a patient, and the channel may include indentations to receive maxillary teeth of the patient. In FIG. 5A, a surface 516 connects the inside wall, across the dental arch. The surface may for example extend from upper edges of the inside wall. The surface may, for example, conform to a palate of the patient, and be positioned so as to be adjacent the palate when the dental appliance is worn by the patient. Accordingly, as a palate of a patient will generally curve upward away from the jaw, towards an apex, the surface in many embodiments also curves upward towards an apex with distance from the inner wall. In some embodiment the surface may be considered to cover (from below) the palate of the patient in the area within an arch formed by the inside wall. In some embodiments the surface may generally conform in shape to the palate of the patient, but be offset by a distance, for example 0.25 mm, 1.0 mm, or between 0.25 and 1.0 mm, from an apex of the palate. In some embodiments the offset from the palate may be at a maximum along an apex of the palate, which may be for example along a mid-line of the palate generally equidistant from opposing molars on opposing sides of the dental arch. In some embodiments the offset from the palate may allow for “dropping” of the palate, resulting in an increase in airway size of nasal passages above the palate.

The inside wall extends upward sufficiently far so as to be parallel to the upper jawbone. In some embodiments the inside wall is in contact with the palatal dome tissue. In some embodiments at least part of the inside wall is in contact with a vertical portion of the palatal dome tissue. In some embodiments the inside wall is in contact with lingual attached gingiva of the user. In some embodiments the inside wall and/or surface 516 extends over at least 3 to 4 mm of the lingual attached gingiva closest to the marginal gingiva. Preferably, the inside wall and/or surface 516 is configured to apply pressure to the upper jawbone, by way of the attached gingiva, in a radially outward or forward direction such that a width and/or length of the dental arch may be increased. In some embodiments the outside wall is in contact with buccal attached gingiva of the user. In some embodiments the outside wall extends over 3 to 4 mm of the buccal attached gingiva closest to the marginal gingiva.

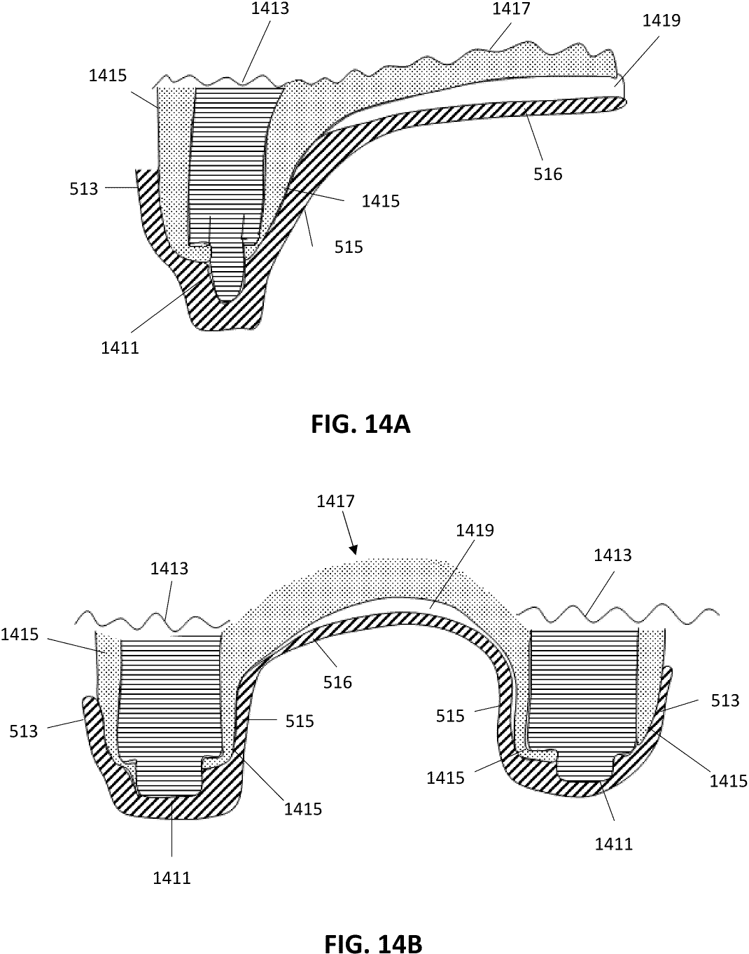

FIGS. 14A and 14B illustrate a side cross-sectional view through an incisor and a molar, respectively, of an embodiment of the maxillary dental appliance of FIG. 5A in use by a user. In FIGS. 14A and 14B only cross-sectional portions of the teeth and dental appliance are shown.

In FIG. 14A, the cross-section is through a central incisor 1411 of the user. The incisor is mounted in and extends downward from the maxillary jaw bone 1413. Surrounding the jaw bone is gingiva 1415. The gingiva includes attached gingiva attached to the jaw bone and free or marginal gingiva about where the tooth extends from the jaw bone. The tooth is in an indentation of the dental appliance of FIG. 5A, for example the indentation 521 of the dental appliance of FIG. 5A. The outside wall 513 of the dental appliance extends over portions of the buccal attached gingiva. In some embodiments the outside wall extends 3 to 4 mm (or more in some embodiments) over the attached gingiva past a line defined by contact between the marginal gingiva and the attached gingiva.

The inside wall 515 of the dental appliance also extends over portions of the attached gingiva, with the inside wall extending over portions of the lingual attached gingiva. The inside wall and/or surface 516 is positioned and/or dimensioned to exert radially outward pressure against the lingual attached gingiva. In some embodiments the inside wall extends at least 3 to 4 mm over the attached gingiva past a line defined by contact between the marginal gingiva and the attached gingiva.

The inside wall transitions to the surface 516 that covers, at least partially, the palatal dome 1417 of the user. About the apex of the palatal bone, the surface is slightly away from the palatal dome. Having the surface away from the palatal dome may allow the palatal dome to drop, possibly increasing nasal airway passage volume, in some embodiments.

In FIG. 14B, the cross-section is through a pair of molars 1411 of the user. The molars are also mounted in and extends downward from the maxillary jaw bone 1413. As with the incisor, surrounding the jaw bone is gingiva 1415, which includes attached gingiva attached to the jaw bone and marginal gingiva about where the teeth extends from the jaw bone. The molars are in indentations of the dental appliance of FIG. 5A, with for example one of the molars being in indentation 523 of the dental appliance of FIG. 5A. The outside wall 513 of the dental appliance extends over portions of the buccal attached gingiva for both molars. In some embodiments the outside wall extends 3 to 4 mm over the attached gingiva past a line defined by contact between the marginal gingiva and the attached gingiva. In some embodiments the outside wall extends 1 to 3 mm over the attached gingiva past a line defined by contact between the marginal gingiva and the attached gingiva.

The inside wall 515 of the dental appliance also extends over portions of the attached gingiva, with the inside wall extending over portions of the lingual attached gingiva. The inside wall is positioned and/or dimensioned to exert radially outward pressure against the lingual attached gingiva. In some embodiments the inside wall extends at least 3 to 4 mm over the attached gingiva past a line defined by contact between the marginal gingiva and the attached gingiva.. In some embodiments the inside wall extends 1 to 3 mm over the attached gingiva past a line defined by contact between the marginal gingiva and the attached gingiva.

The inside wall, about each molar, transitions to the surface 516 that covers the palatal dome 1417. About a top or apex of the palatal dome, the surface 516 is not in contact with the palatal dome. Instead, the surface is somewhat distal from the apex of the palatal dome, allowing for “dropping” of the palatal dome.

The embodiment of FIGS. 14A and 14B may be considered to fully encase the teeth of the user with respect to the jaw bone of the user. The embodiment of FIGS. 14A and 14B may therefore allow radially outward pressure to be applied by the dental appliance to the jaw bone through the attached gingiva, without application of pressure to the teeth that may result in the teeth being excessively or undesirably angled outward or flared or tilted from the jaw bone or displaced towards the buccal edge of the jaw bone, possibly preventing gum recission or bone loss.

The device of FIG. 5A may, for example, be one of a sequence of dental appliances. In some embodiments, each successive dental appliance in the sequence may include an inside wall that is farther radially forward for example by the directions of arrows in FIG. 5A, than an immediately prior dental appliance in the sequence. In some embodiments the outside wall may be farther radially forward by an equivalent amount, with the channel also therefore being farther radially forward. In some embodiments the inside wall may be farther radially forward in a range of 0.1 to 0.5 mm. In some embodiments the inside wall may be farther radially forward in a range of 0.15 to 0.3 mm. In some embodiments the inside wall may be farther radially forward in a range of 0.18 to 0.25 mm. In some embodiments the inside wall may be farther radially forward in a range of 0.16 to 0.20 mm. In some embodiments the inside wall may be farther radially forward in a range of 0.23 to 0.27 mm. In some embodiments some portions of the inside wall may be farther radially forward than other portions of the inside wall. For example, some users may have dental arches not symmetrical with respect to a vertical plane bisecting their face into two halves. In such circumstances, and others, it may be desirable to have some portions of the inside wall farther radially forward than other portions, for example to increase bilateral symmetry of the dental arch. For example, in some circumstances it may be desirable for the dental appliances to apply greater pressure in some areas to provide greater jaw bone growth in those areas than other areas, for example to reduce empty space (which may be termed buccal black space) between a user’s cheeks and buccal gingiva and teeth surfaces.

In some embodiments the surface conforming to, or slightly offset from, the palate, or in many embodiments an apex of the surface, is also slightly lower for some or each successive dental appliance in the sequence. In some embodiments any particular dental appliance in the sequence may have an apex of the surface 0.25 to 2.0 mm, or 0.25 to 1.0 mm, or 1.0 to 2.5 mm lower than the apex of the user’s palate at a time the user is to begin use of that particular dental appliance. In some embodiments the surface may be 0.25 to 1.0 mm lower for some successive dental appliances, or each successive dental appliance in some embodiments, for example to accommodate lowering of the palate with use of each successive dental appliance. In some embodiments the surface may be 0.25 mm lower for some successive dental appliances, or each successive dental appliance in some embodiments, for example to accommodate lowering of the palate with use of each successive dental appliance. Successive use of the dental appliances, therefore, may result in increase in width and/or length of the dental arch, and in some embodiments may result in lowering of the palate, and possible increase in airway size in nasal passages above the palate.

In some embodiments the dental appliances include indentations for teeth. In some embodiments the indentations are each dimensioned to encapsulate each tooth beyond the gumline, or to encapsulate each tooth to the extent possible accounting for any contact between proximal tooth surfaces. In some embodiments the indentations for the teeth are generally each dimensioned to receive the biting surface of a tooth and, in some or all cases, to contact at least one side surface of the tooth. In some embodiments the indentations for the teeth, or one or some of the indentations, may be sufficiently deep so that at least one wall of indentations may be used to exert lateral pressure or force on a side surface (e.g., facial, lingual, or proximal surface) of a tooth in the indentation so as to allow for repositioning of the tooth in the dental arch. In some embodiments positions of the indentations for the teeth are determined for at least some of the dental appliances in the sequence of dental appliances so as to orthodontically position the teeth. For example, some users may not have teeth substantially positioned so as to be centered on a smooth curve preferably defined by their dental arch, or the teeth may not be symmetrically positioned about a vertical center line of a face of a head including the dental arch, or various of the teeth may not have a desired distance between proximal surfaces, or some or all of the teeth may not have facial surfaces substantially parallel to the smooth curve preferably defined by their dental arch. In such cases, positions of the indentations for the teeth may be determined so as to exert pressure on appropriate side surfaces (e.g., facial, lingual, or proximal surfaces) of improperly positioned teeth so as to move the teeth to desired positions. In addition, as an increase in length and/or width of the dental arch may tend to result in increases in distance between teeth proximal surfaces, the positions of the indentations for the teeth may be determined so as to exert pressure on side surfaces of selected teeth to achieve a desired spacing between teeth.

FIG. 5B shows an upper rear internal perspective view of a further maxillary dental appliance in accordance with aspects of the invention. The further maxillary dental appliance of FIG. 5B may be a dental appliance in the same sequence of dental appliances as that of FIG. 5A, and in some embodiments may be an ultimate dental appliance in that sequence. The further maxillary dental appliance of FIG. 5B is substantially the same as the dental appliance of FIG. 5A, with a channel 511b, defined by an outside wall 513b and an inside wall 515b, to accept teeth of a maxillary dental arch. As with the dental appliance of FIG. 5A, the inside wall of the dental appliance of FIG. 5B is configured to apply pressure to the upper jawbone in an outward direction.

For the dental appliance of FIG. 5B, however, the dental arch is differently positioned. The dental appliance of FIG. 5B is for a dental arch that has a greater width and/or length, a greater width and/or length due to increases in width and/or length caused by use of one or more prior dental appliances in the sequence. In addition, in some embodiments the surface 516 connecting the inside wall across the dental arch of FIG. 5B also has a lower apex than that of FIG. 5A, for example so as to allow for lowering of a palate of a user of the dental arch.

In FIGS. 5A and 5B, the increase in dental arch width is illustrated, among other ways, in differences in intercanine width and second interpremolar width. In FIG. 5A, intercanine width 517a is a first distance, while in FIG. 5B, intercanine width 517b is a second distance, the second distance being greater than the first distance. Similarly, for the dental appliance of FIG. 5A, a second interpremolar width 519a is less than a second interpremolar width 519b of the dental appliance of FIG. 5B.

In some embodiments the position and/or rotational orientation of indentations in the channel for the teeth may also be comparatively adjusted between dental appliances in the sequence. Absent comparative adjustment of the indentations for the teeth, as the dental arch increases in width and/or length, distance between the teeth would also increase. With adjustment of the position of indentations for the teeth, however, the teeth may also be orthodontically positioned as desired. In some embodiments the positions of the indentations are selected such that the teeth are substantially positioned so as to be centered on a smooth curve preferably defined by their dental arch, with the teeth symmetrically positioned about a vertical center line of a face of a head including the dental arch, with the teeth having a desired distance between proximal surfaces, and with the teeth having facial surfaces substantially parallel to the smooth curve preferably defined by their dental arch. In some embodiments the positions of the indentations are selected such that only one or some of the above listed desired positioning objectives are achieved.

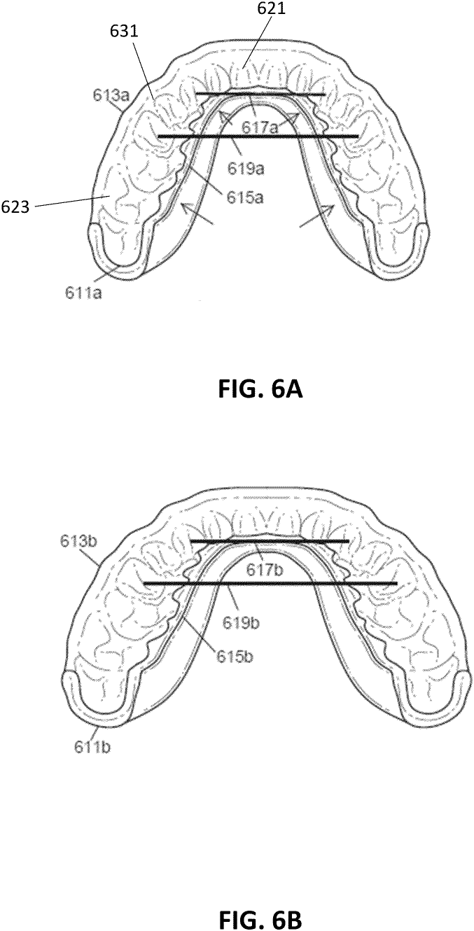

FIG. 6A shows a lower rear internal perspective view of a mandibular dental appliance in accordance with aspects of the invention. As with the maxillary dental appliance, a generally U-shaped channel 611a is defined on its sides by an outside wall 613a and an inside wall 615a. The U-shaped channel generally follows a path of a dental arch, for example of a patient, and the channel may include indentations to receive mandibular teeth of the patient.

The inside wall extends downward sufficiently far so as to be parallel to the portion of the body of the mandible holding the mandibular teeth. In some embodiments the inside wall extends sufficiently far so as to be parallel to and in contact with the lingual attached gingiva for the mandibular teeth. In some embodiments the inside wall extends sufficiently far so as to cover 3 to 4 mm of attached gingiva below the marginal gingiva. Preferably, the inside wall is sufficiently radially forward so as to apply pressure to the bone, via the lingual attached gingiva, in an outward direction such that a width and/or length of the dental arch is increased. In some embodiments the inside wall extends below a gumline for the mandibular teeth. In some embodiments the inside wall extends 4 to 5 mm below the gumline for the mandibular teeth. In some embodiments the outside wall may be slightly radially forward than would be expected for a close fit for the mandibular teeth, allowing for movement of the teeth as the dental arch increases.

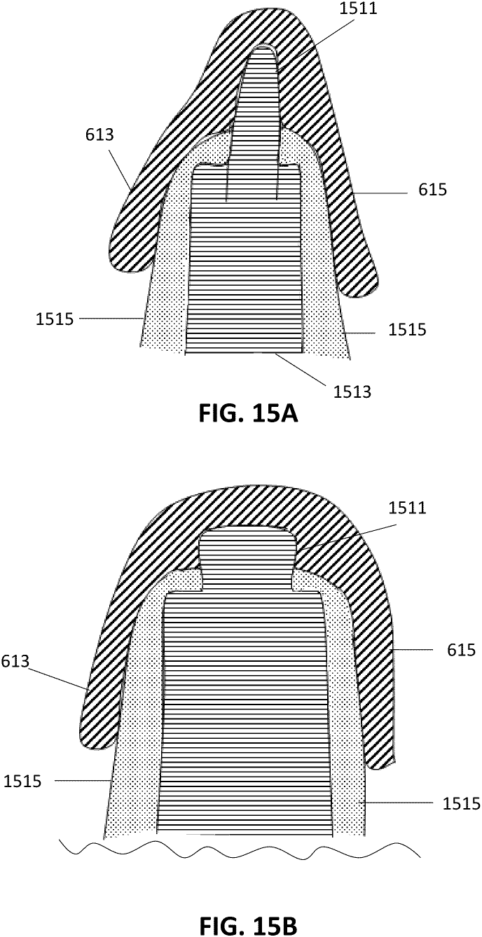

FIGS. 15A and 15B illustrate a side cross-sectional view through an incisor and a molar, respectively, of an embodiment of the mandibular dental appliance of FIG. 6A in use by a user. In FIGS. 15A and 15B only cross-sectional portions of the teeth and dental appliance are shown.

In FIG. 15A, the cross-section is through a central incisor 1511 of the user. The incisor is mounted in and extends upward from the mandibular jaw bone 1513. Surrounding the jaw bone is gingiva 1515. The gingiva includes attached gingiva attached to the jaw bone and marginal gingiva about where the tooth extends from the jaw bone. The tooth is in an indentation of the dental appliance of FIG. 6A, for example the indentation 621 of the dental appliance of FIG. 6A. The outside wall 613 of the dental appliance extends over portions of the buccal attached gingiva. In some embodiments the outside wall extends 3 to 4 mm over the attached gingiva past a line defined by contact between the marginal gingiva and the attached gingiva.

The inside wall 615 of the dental appliance also extends over portions of the attached gingiva, with the inside wall extending over portions of the lingual attached gingiva. The inside wall is positioned and/or dimensioned to exert radially outward pressure against the lingual attached gingiva. In some embodiments the inside wall extends at least 3 to 4 mm over the attached gingiva past a line defined by contact between the marginal gingiva and the attached gingiva.

In FIG. 14B, the cross-section is through a molar 1511 of the user. The molar is also mounted in and extends upward from the mandibular jaw bone 1513. As with the incisor, surrounding the jaw bone is gingiva 1515, which includes attached gingiva attached to the jaw bone and marginal gingiva about where the teeth extends from the jaw bone. The molar is in an indentation of the dental appliance of FIG. 6A, with for example the molars being in indentation 623 of the dental appliance of FIG. 6A. The outside wall 613 of the dental appliance extends over portions of the buccal attached gingiva for both molars. In some embodiments the outside wall extends 3 to 4 mm over the attached gingiva past a line defined by contact between the marginal gingiva and the attached gingiva.

The inside wall 615 of the dental appliance also extends over portions of the attached gingiva, with the inside wall extending over portions of the lingual attached gingiva. The inside wall is positioned and/or dimensioned to exert radially outward pressure against the lingual attached gingiva. In some embodiments the inside wall extends at least 3 to 4 mm over the attached gingiva past a line defined by contact between the marginal gingiva and the attached gingiva.

As with the embodiment of FIGS. 14A and 14B, the embodiment of FIGS. 15A and 15B may be considered to fully encase the teeth of the user with respect to the jaw bone of the user. The embodiment of FIGS. 15A and 15B may therefore allow radially outward pressure to be applied by the dental appliance to the jaw bone through the attached gingiva, without application of pressure to the teeth that may result in the teeth being excessively or undesirably angled outward from the jaw bone or displaced towards the buccal edge of the jaw bone, which possibly may cause bone or tissue loss.

As with the dental appliance of FIG. 5A, the device of FIG. 6A may, for example be one of a sequence of dental appliances. In some embodiments, each successive dental appliance in the sequence may include an inside wall that is farther radially forward for example by the directions of arrows in FIG. 6A, than an immediately prior dental appliance in the sequence. In some embodiments the outside wall may be farther radially forward by an equivalent amount, with the channel also therefore being farther radially forward. In some embodiments the inside wall may be farther radially forward in a range of 0.1 to 0.5 mm, or more as dictated by user anatomy. In some embodiments the inside wall may be farther radially forward in a range of 0.15 to 0.3 mm. In some embodiments the inside wall may be farther radially forward in a range of 0.18 to 0.25 mm. In some embodiments the inside wall may be farther radially forward in a range of 0.16 to 0.20 mm. In some embodiments the inside wall may be farther radially forward in a range of 0.23 to 0.27 mm. In some embodiments some portions of the inside wall may be farther radially forward than other portions of the inside wall. For example, some users may have dental arches not symmetrical with respect to a vertical plane bisecting their face into two halves. In such circumstances, and others, it may desirable to have some portions of the inside wall farther radially forward than other portions, for example to increase bilateral symmetry of the dental arch or to reduce buccal empty space. Successive use of the dental appliances, therefore, may result in increase in width and/or length of the dental arch. In addition, in some embodiments the dental appliances include indentations for teeth, and positions of the indentations for the teeth may orthodontically position the teeth as the width and/or length of the dental arch is modified. As with the sequence of dental appliances discussed with respect to FIG. 5A, the indentations for the teeth, or one or some of the indentations, may be sufficiently deep so that at least one wall of indentations may be used to exert lateral pressure or force on a side surface (e.g., facial, lingual, or proximal surface) of a tooth in the indentation so as to allow for repositioning of the tooth in the dental arch. Also as discussed with respect to FIG. 5A, positions of the indentations for the teeth may be determined so as to exert pressure on appropriate side surfaces of improperly positioned teeth so as to move the teeth to desired positions or to exert pressure on side surfaces of selected teeth to achieve a desired spacing between teeth.

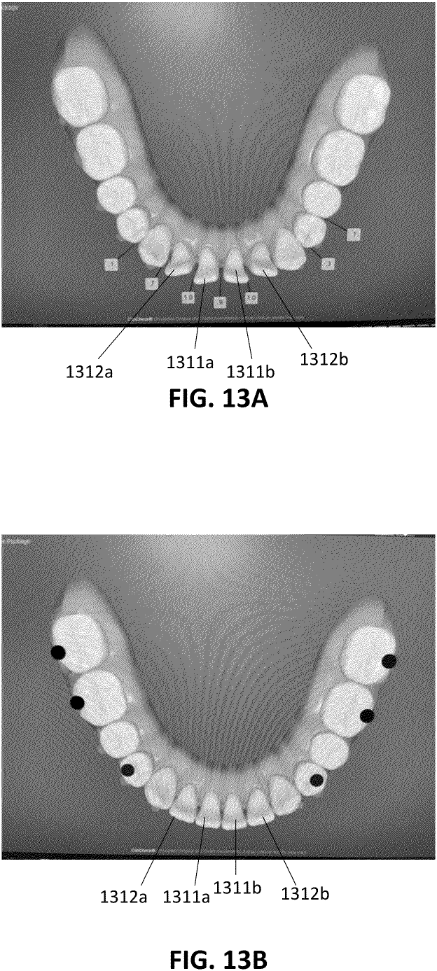

As an example, FIG. 13A illustrates a top view of an example mandibular dental arch in which the incisors have larger than desired spacing between adjacent teeth and facial or labial surfaces that are not substantially parallel to a smooth curve defined by the dental arch. More particularly, the central incisors 1311a,b have excess space between their adjacent proximal surfaces, and are rotationally oriented inward about their long axis. Similarly, proximal surfaces of the lateral incisors 1312a,b are spaced farther apart from adjacent proximal surfaces of their neighboring central incisors, and the lateral incisors also are rotationally oriented inward about their long axis. Positioning of the indentations for the teeth, however, may allow for repositioning of the incisors. FIG. 13B illustrates an example of desired relative teeth positioning after use of the sequence of dental appliances. In FIG. 13B, for example, the central incisors 1311a,b and the lateral incisors 1312a,b have facial or labial surfaces that are substantially parallel to a smooth curve defined by the dental arch. In addition, excessive gaps between proximal surfaces of the central incisors and between proximal surfaces of adjacent lateral incisors and central incisors have been reduced.

FIG. 6B shows a lower rear internal perspective view of a further mandibular dental appliance in accordance with aspects of the invention. The further mandibular dental appliance of FIG. 6B may be a dental appliance in the same sequence of dental appliances as that of FIG. 6A, and in some embodiments may be an ultimate dental appliance in that sequence. The further mandibular dental appliance of FIG. 5B is substantially the same as the dental appliance of FIG. 5A, with a channel 611b, defined by an outside wall 613b and an inside wall 615b, to accept teeth of a mandibular dental arch. As with the dental appliance of FIG. 6A, the inside wall of the dental appliance of FIG. 6B extends sufficiently far so as to apply pressure to the mandibular bone in an outward direction.

For the dental appliance of FIG. 6B, however, the dental arch is differently positioned. The dental appliance of FIG. 6B is for a dental arch that has a greater width and/or length, a greater width and/or length due to increases in width and/or length caused by use of one or more prior dental appliances in the sequence.

In FIGS. 6A and 6B, the increase in dental arch width is illustrated, among other ways, in differences in intercanine width and second interpremolar width. In FIG. 6A, intercanine width 617a is a first distance, while in FIG. 6B, intercanine width 617b is a second distance, the second distance being greater than the first distance. Similarly, for the dental appliance of FIG. 6A, a second interpremolar width 619a is less than a second interpremolar width 619b of the dental appliance of FIG. 6B.

In some embodiments the position of indentations in the channel for the teeth may also be comparatively adjusted between dental appliances in the sequence. Absent comparative adjustment of the indentations for the teeth, as the dental arch increases in width and/or length, distance between the teeth would also increase. With adjustment of the position of indentations for the teeth, however, the teeth may also be orthodontically positioned as desired, at the same time in some embodiments, for example as discussed above with respect to FIG. 5B.

In some embodiments the sequence of dental appliances discussed with respect to FIGS. 5A and 5B and FIGS. 6A and 6B, respectively, may be used together, with the width and/or length of the upper and lower dental arches being moved in unison, along with orthodontic teeth positioning, in some embodiments.

In some embodiments the dental appliances of FIGS. 5A, 5B, 6A, 6B, and other dental appliances in a sequence of such dental appliances are formed of a polymer. In some embodiments the dental appliances are formed of or comprise one, some or all of polyethylene terephthalate (PET), polyethylene terephthalate glycol (PET-G), PET (Pfb/PFc), Polyurethane, a multi-layer polyurethane, or a multi-layer aromatic thermoplastic polyurethane. In some embodiments the dental appliances are formed of an acrylic. In some embodiments the dental appliances are formed of an acrylic resin. In some embodiments, as one of ordinary skill in the art would necessarily understand, the polymer is of sufficient rigidity to be capable of exerting pressure with respect to the bones underlaying the dental arch and, in some embodiments, to the teeth of the dental arch.

In some embodiments information provided by casts of a maxillary dental arch and palate and/or a cast of a mandibular dental arch, or for example by imaging of teeth, and possibly bone positions in some embodiments, may be used in making an entire sequence of dental appliances. After the dental appliances are used for a period of time, one week in some embodiments, a period of time expected to result in 120 hours or more per week of patient use of the dental appliances in some embodiments, further casts may be made for use in making subsequent dental appliances in a sequence of dental appliances.

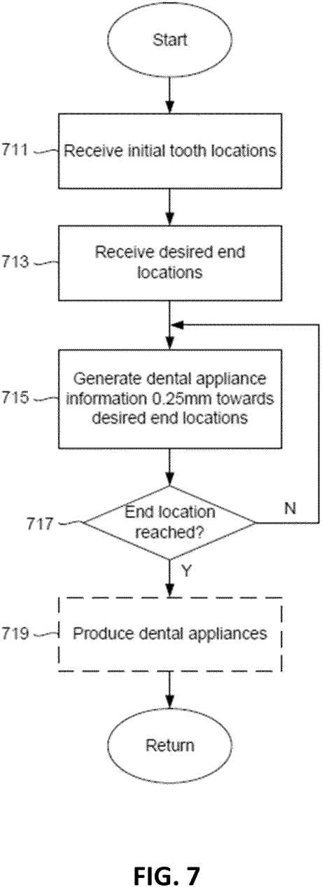

FIG. 7 is a flow diagram of a process that may be used in making a sequence of dental appliances. The dental appliances may be the sequence of dental appliances discussed with respect to FIGS. 5A-6B. In some embodiments the process is performed, at least in part, by a computer. In some embodiments dental appliance production information is generated using a computer. In some embodiments the computer includes at least one processor, associated memory, and at least one user input device. In some embodiments the computer is a server. In some embodiments the computer is coupled to a network, for example a local area network and/or the Internet, and different computers and/or servers may perform different parts of the process.

In block 711 the process receives information of initial tooth and/or dental arch locations for a patient. The information of initial tooth and/or dental arch locations may be derived from a cast of the patient’s dental arches, for example, in some embodiments the information of initial tooth and/or dental arch locations may be derived from imaging of the patient’s dental arches. In some embodiments the information includes information of palate location/position, or of an apex of the palate, for some or all locations within the dental arch.

In block 713 the process receives information of desired tooth and/or dental arch locations. The desired locations may be desired tooth and/or dental arch locations after use of a sequence of dental appliances to increase width and/or length of the patient’s dental arches. In some embodiments the information of the desired tooth locations includes information as to desired tooth rotational orientation about the tooth’s long axis. In some embodiments the tooth desired locations are one, some, or all of: centered on a smooth curve defining a desired dental arch, symmetrical about a vertical center line of a face of a head including the dental arch, and/or having a rotational orientation about a long axis of the tooth such that a facial surface of the tooth is substantially parallel to the smooth curve defining the desired dental arch, and/or providing for a predetermined desired spacing between proximal surfaces of adjacent teeth. In some embodiments the process may also receive a desired location or locations for an apex of the palate of the patient.

In block 715 the process generates information of a dental appliance to increase width and/or length of the patient’s dental arches by a predetermined amount. In some embodiments the process also generates information of the dental appliance to modify tooth indentation position or rotational orientation so as to modify tooth position along the dental arch or tooth long axis rotational orientation of one, some, or all of the teeth. In some embodiments the predetermined amount is between 0.15 and 0.30 mm. In some embodiments the predetermined amount is between 0.18 and 0.25 mm. In some embodiments the predetermined amount is 0.18 mm. In some embodiments the predetermined amount is 0.25 mm. In some embodiments a direction of increase is determined based on differences between a current position and a desired position for same portions of the dental arches. In some embodiments positions of the portions are based on positions of the same teeth. In some embodiments the generated information includes information of position of a surface connecting the dental arch of the upper or maxillary dental appliance, or an apex of the surface.

In block 717 the process determines if the information of the dental appliance of block 715 indicates that the desired end locations of the tooth and/or dental arch locations have been reached, or, in some embodiments, are within a predetermined range of being reached. If not, the process returns to operations of block 715, and generates a further dental appliance in the sequence, with the location information of teeth and/or dental arches presumed to be those locations as adjusted by use of a dental appliance produced in accordance with the information of the prior dental appliance generated in the immediately prior operations of block 715. If the desired end locations have been reached, the process continues to block 719.

In block 719, dental appliances are produced based the information generated in successive operations of block 715. In some embodiments operations of block 719 are performed outside of the process of FIG. 7, for example as part of another process. In some embodiments the operations of block 719 are performed by a molding machine, or some other machine.

The process thereafter returns.

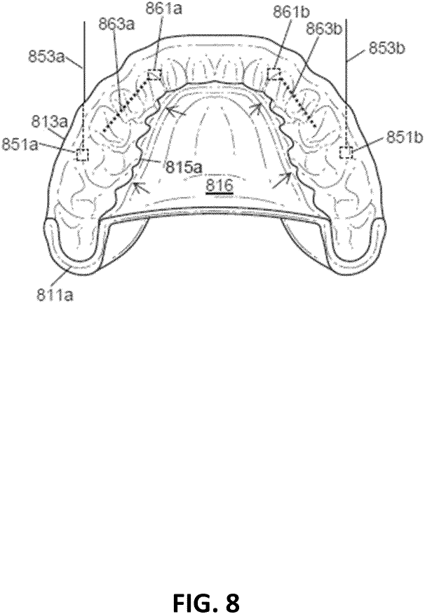

FIG. 8 shows an upper rear perspective view of a further maxillary dental appliance in accordance with aspects of the invention. The maxillary dental appliance of FIG. 8 generally mirrors that of FIG. 5A, with the exception that the appliance of FIG. 8 includes hooks 851a,b for holding elastic bands 853a,b attached to a facemask, for example to apply radially forward pressure to the dental appliance. The appliance also includes hooks 861a,b for holding elastic bands 863a,b attached to a mandibular dental appliance for providing class II elastics.

As in FIG. 5A, the dental appliance of FIG. 8 has a generally U-shaped channel 811a defined on its sides by an outside wall 813a and an inside wall 815a. The U-shaped channel generally follows a path of a dental arch, for example of a patient, and the channel may include indentations to receive maxillary teeth of the patient. A surface 816 connects the inside wall, across the dental arch. The surface may, for example, conform to a palate of the patient, and be positioned so as to be adjacent or offset from the palate, or an apex of the palate, when the dental appliance is worn by the patient.

The inside wall extends upward sufficiently far so as to be parallel to the upper jawbone, and in some embodiments in contact with the palatal dome tissue of the upper jawbone. In some embodiments the inside wall is in contact with a vertical portion of the palatal dome tissue. In some embodiments the inside wall extends upwards so as to be above a gumline, in some embodiments above the gumline by 4 to 5 mm. Preferably, the inside wall is configured to apply pressure to the upper jawbone, in an outward direction such that a width and/or length of the dental arch may be increased. Concomitantly, the outside wall may be slightly radially forward than would be expected for a close fit for the maxillary teeth, allowing for movement of the teeth as the dental arch increases.

The device of FIG. 8 may be one of a sequence of dental appliances, for example as discussed with respect to FIG. 5A. As discussed with respect to FIG. 5A, in some embodiments, each successive dental appliance in the sequence may include an inside wall that is farther radially forward for example by the directions of arrows in FIG. 8, than an immediately prior dental appliance in the sequence. In some embodiments the outside wall may be farther radially forward by an equivalent amount, with the channel also therefore being farther radially forward. In addition, the surface connecting opposing sides of the dental arch, or the apex of the surface, may be lowered in each successive dental appliance, to allow for lowering of the patient’s palate. Successive use of the dental appliances, therefore, may result in increase in width and/or length of the dental arch.

The hooks 851a,b are mounted to the exterior of opposing sides of the outer wall. As illustrated in FIG. 8, the hooks are mounted about positions of the first molar, although the hooks may be positioned about other tooth locations in various embodiments. Elastic bands 853a,b are coupled to the hooks 851a,b, respectively. The elastic bands extend outwardly past a front of the dental appliance, for coupling to a cross-bar or other portion of a facemask to be worn by the patient. The elastic bands are preferably under tension, so as to transmit a radially forward force to the dental appliance as a whole by way of the hooks.

The hooks 861a,b are also mounted to the exterior of opposing sides of the outer wall. As illustrated in FIG. 8, the hooks are mounted about positions of the canines, although the hooks may be positioned about other tooth locations in various embodiments. Elastic bands 863a,b are coupled to the hooks 861a,b, respectively. The elastic bands extend rearwardly and slightly downward, for coupling to hooks on an outer wall of a mandibular dental appliance. The hooks on the mandibular dental appliance may be about positions of the lower molars, although the hooks may be positioned about other tooth locations in various embodiments. The use of the hooks 861a,b and elastic bands 863a,b may be used in providing class II elastics, and may serve to temporarily move the mandible of the patient radially forward, to possibly reduce snoring and possibly provide for increased opening of the patient’s airway, at least temporarily.

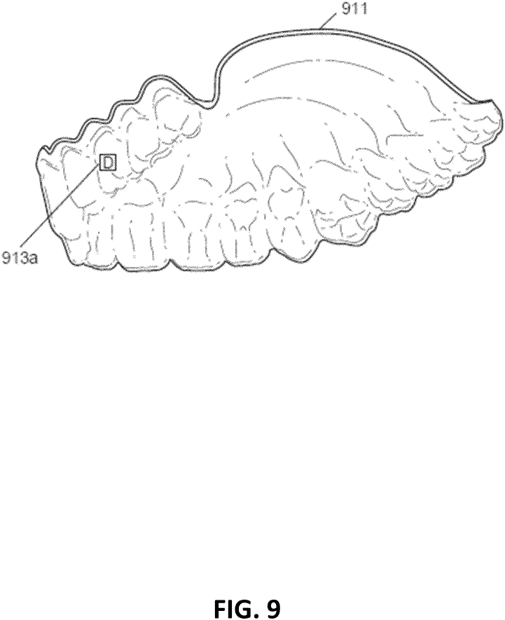

FIG. 9 shows a lower rear perspective view of the example maxillary dental appliance 911 of FIG. 8, with a representation of a hook 913a attached about a position a first molar. A corresponding hook would be attached on an opposing side of the dental appliance, about a position of the opposing first molar. Further hooks may be attached about positions of the canines, for example for use in providing class II elastics.

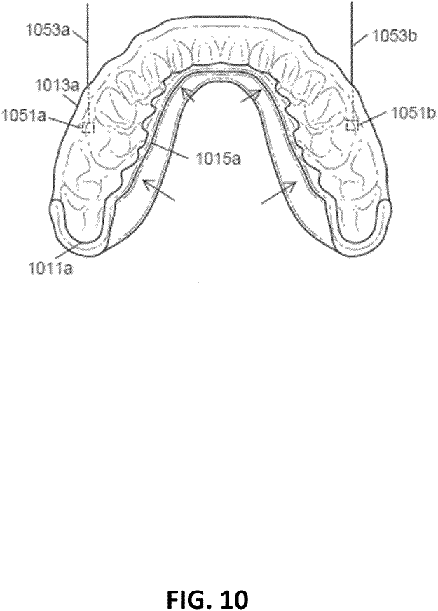

FIG. 10 shows a lower rear perspective view of a further mandibular dental appliance in accordance with aspects of the invention. The mandibular dental appliance of FIG. 10 generally mirrors that of FIG. 6A, with the exception that the appliance of FIG. 10, like that of FIG. 8, includes hooks 1051a,b for holding elastic bands 1053a,b attached to hooks on the maxillary dental appliance for use in providing class II elastics, for example to apply radially forward pressure to the mandibular dental appliance.

As with the maxillary dental appliance of FIG. 6A, the dental appliance of FIG. 10 generally U-shaped channel 1011a is defined on its sides by an outside wall 1013a and an inside wall 1015a. The U-shaped channel generally follows a path of a dental arch, for example of a patient, and the channel may include indentations to receive mandibular teeth of the patient.

The inside wall extends downward sufficiently far so as to be parallel to the portion of the body of the mandible holding the mandibular teeth. Preferably, the inside wall is sufficiently radially forward so as to apply pressure to the bone, in an outward direction such that a width and/or length of the dental arch. In some embodiments the inside wall extends below a gumline for the mandibular teeth. In some embodiments the inside wall extends 4 to 5 mm below the gumline for the mandibular teeth. Concomitantly, the outside wall may be slightly radially forward than would be expected for a close fit for the mandibular teeth, allowing for movement of the teeth as the dental arch increases.

As with the dental appliances of FIGS. 5A and 6A, the dental appliance of FIG. 10 may, for example be one of a sequence of dental appliances, for example as discussed with respect to FIGS. 5A and 6A. In some embodiments, each successive dental appliance in the sequence may include an inside wall that is farther radially forward for example by the directions of arrows in FIG. 10, than an immediately prior dental appliance in the sequence. In some embodiments the outside wall may be farther radially forward by an equivalent amount, with the channel also therefore being farther radially forward. Successive use of the dental appliances, therefore, may result in increase in width and/or length of the dental arch.

The hooks 1051a,b are mounted to the exterior of opposing sides of the outer wall. As illustrated in FIG. 10, the hooks are mounted about positions of the first molar, although the hooks may be positioned about other tooth locations in various embodiments. Elastic bands 1053a,b are coupled to the hooks 1051a,b, respectively. The elastic bands extend outwardly towards a front of the mandibular dental appliance, and slightly upward, for coupling to hooks on a maxillary dental appliance, for example about positions of the canines. The hooks and elastic bands may be used in providing a class II elastic. The elastic bands are preferably under tension, so as to transmit a radially forward force to the dental appliance as a whole by way of the hooks.

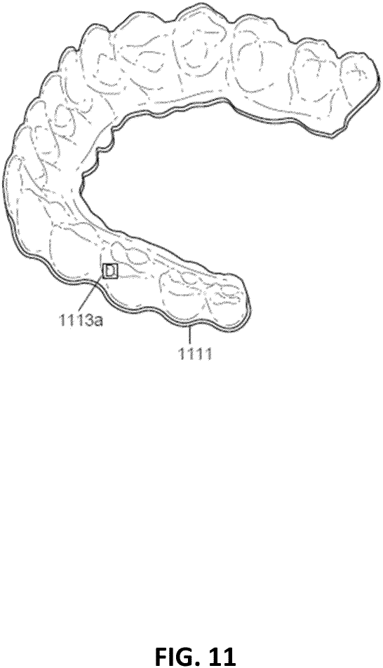

FIG. 11 shows an upper rear perspective view of the example mandibular dental appliance 1011 of FIG. 10, with a representation of a hook 1113a attached about a position a first molar. A corresponding hook would be attached on an opposing side of the dental appliance, about a position of the opposing first molar.

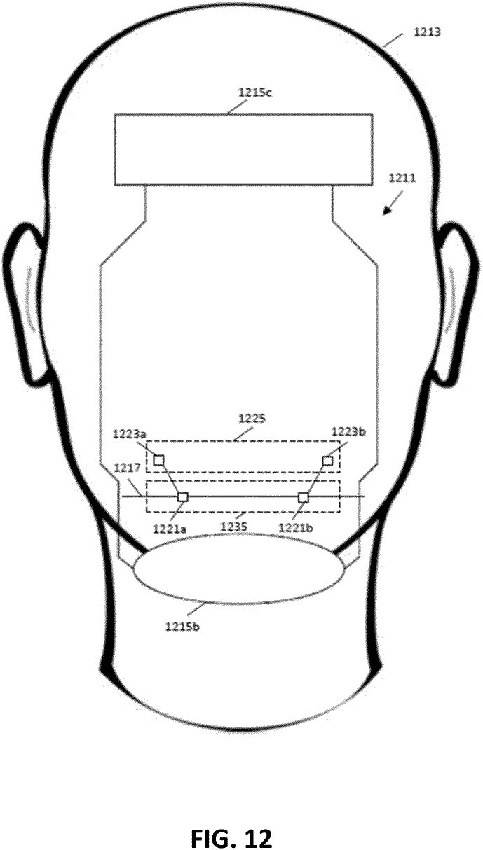

For completeness, FIG. 12 diagrammatically shows a facemask 1211 on a head 1213 of a patient. The facemask includes an upper pad 1215a for placement against a forehead of the patient, and a lower pad 1215b for placement against a chin of the patient. Generally vertical bars couple the upper pad the lower pad, about sides of the patient’s face. A horizontal cross-bar 1217 couples the vertical bars, with the cross-bar positioned somewhat below a level of the patient’s mouth. In various embodiments the cross-bar is positioned approximately 15-20 degrees below a level, or horizon, defined by the patient’s mouth.

A pair of couplings 1221a,b are coupled to the cross-bar. Elastic bands extend between each of the couplings and corresponding hooks 1223a,b on a maxillary dental appliance 1225. The maxillary dental appliance 1225 and a mandibular dental appliance 1235 may be as discussed with respect to FIGS. 8-11. The elastic bands are preferably under tension, so as to both press the facemask against the forehead and chin of the patient, and to pull radially forward the maxillary and dental appliance. In some embodiments the elastic bands may be coupled directly to the cross-bar.

Although the invention has been described with respect to certain embodiments, it should be recognized that the invention comprises the novel and nonobvious claims supported by this disclosure.

What is claimed is:

1. Dental appliances for jaw remodeling and at least partially simultaneous teeth positioning, comprising:
a plurality of dental appliances, each dental appliance including an outside wall and an inside wall, with a channel to receive teeth of a dental arch between the outside wall and the inside wall, the channel including indentations to receive at least some of the teeth of the dental arch, the inside wall extending so as to be parallel to at least one bone structure supporting teeth of the dental arch, so as to apply pressure to the at least one bone structure in a direction towards a surface defined by the outside wall;
wherein the dental appliances provide a succession of dental appliances, each of the dental appliances in the succession having inside walls having a greater arch width and/or length than a prior dental appliance in the succession; and
wherein at least some of the dental appliances in the succession have at least some indentations positioned in the channel so as to provide linear and/or rotational pressure to teeth positioned in the indentations.

2. The dental appliances of claim 1, wherein the indentations of at least some of the dental appliances in the succession are positioned to apply linear and/or rotational pressure to teeth such that the teeth have a mid-line in a middle of a user’s face.

3. The dental appliance of claim 1, wherein the indentations of at least some of the dental appliances in the succession are positioned to apply linear and/or rotation pressure to teeth so as to substantially position the teeth on a smooth curve defined by the dental arch.

4. The dental appliance of claim 1, wherein the indentations of at least some of the dental appliances in the succession are positioned to apply linear and/or rotational pressure to teeth so as to move teeth to obtain a desired spacing between teeth.

5. The dental appliance of claim 1, wherein the inside wall is dimensioned to extend over at least 3 mm of lingual attached gingiva of a user.

6. The dental appliance of claim 1, wherein the outside wall is dimensioned to extend over at least 1 mm of buccal attached gingiva of a user.

7. The dental appliances of claim 1, wherein each dental appliance in the succession has an arch width and/or length between 0.15 and 0.30 millimeters greater than an arch width and/or length of an immediately preceding dental appliance in the succession.

8. The dental appliances of claim 1, wherein the dental appliances comprise maxillary dental appliances.

9. The dental appliances of claim 8, wherein the maxillary dental appliances include a surface extending across the dental arch, with the surface configured so as to be about a palate of an individual who is to wear the maxillary dental appliances.

10. The dental appliances of claim 9, wherein the surface extends from upper edges of the inside wall of the maxillary dental appliance.

11. The dental appliances of claim 10, wherein the surface connects the upper edges of the inside wall of the maxillary dental appliance.

12. The dental appliances of claim 10, wherein an apex of the surface of each maxillary dental appliance in the succession of dental appliances is configured to be between 0.25 mm and 1.0 mm below an apex of an immediately prior maxillary dental appliance in the sequence of dental appliances.

13. The dental appliances of claim 1, wherein the dental appliances comprise mandibular dental appliances.

14. The dental appliances of claim 1, wherein the dental appliances are formed of a polymer.

15. The dental appliances of claim 14, wherein the polymer is an acrylic polymer.

16. The dental appliances of claim 1, wherein the positions of the indentations for at least some of the teeth provide for orthodontic positioning of the at least some of the teeth by at least some of the different ones of the dental appliances.

17. The dental appliances of claim 1, wherein the indentations are dimensioned for teeth of a primary dentition.

18. The dental appliances of claim 1, wherein the indentations are dimensioned for teeth of an adult dentition.

19. The dental appliances of claim 1, wherein the indentations are dimensioned for teeth of a mixed dentition.

20. A method of jaw remodeling with at least partially simultaneous teeth positioning, comprising:
applying radially outward pressure to lingual attached gingiva of a dental arch using a dental appliance having indentations substantially encasing portions of teeth extending beyond a gum line of an individual; and
simultaneously with the application of radially outward pressure to the lingual attached gingiva using the dental appliance, applying linear and/or rotational pressure to at least some of the teeth using the dental appliance, so as to reposition the teeth with respect to the dental arch.

21. The method of claim 20, further comprising:
applying radially outward pressure to the lingual attached gingiva of the dental arch using a succession of further dental appliance having indentations substantially encasing portions of teeth extending beyond the gum line of the individual; and
simultaneously with the application of radially outward pressure to the lingual attached gingiva using at least some of the further dental appliances, applying linear and/or rotational pressure to at least some of the teeth using the at least some of the further dental appliances, so as to reposition the teeth with respect to the dental arch.

22. The method of claim 21, wherein the dental appliance and the succession of further dental appliances are used in a sequence.

23. The method of claim 22, wherein the succession of further dental appliances follow the dental appliance in the sequence.

24. The method of claim 22, wherein a first dental appliance in the sequence is not the dental appliance and is not one of the at least some of the further dental appliances.

25. The method of claim 20, wherein the linear and/or rotational pressure applied to teeth applies the pressure such that the teeth have a mid-line in a middle of a user’s face.

26. The method of claim 21, wherein the at least some of the dental appliances orthodontically position the teeth through positioning of the indentations.

27. The method of claim 20, wherein the dental appliance includes an outside wall and an inside wall, with a channel to receive teeth of a dental arch between the outside wall and the inside wall, and the inside wall applies the pressure to the lingual attached gingiva.

28. The method of claim 27, wherein the inside wall extends at least 3 mm over the lingual attached gingiva past a line demarcating a boundary between marginal gingiva and the lingual attached gingiva.

29. The method of claim 28, wherein the outside wall extends at least 3 mm over buccal attached gingiva past a line demarcating a boundary between marginal gingiva and the buccal attached gingiva.

30. The method of claim 20, wherein the teeth are teeth of a primary dentition or a mixed dentition.
